(19) United States
(12) Patent Application Publication
(10) Pub. No.: US 2017/0085208 A1
(43) Pub. Date: Mar. 23, 2017

(54) VEHICULAR OPENING/CLOSING BODY CONTROL DEVICE

(71) Applicant: Aisin Seiki Kabushiki Kaisha, Kariya-shi (JP)

(72) Inventors: Yosuke YAMAMOTO, Nagoya-shi (JP); Yasuhiro Awata, Kariya-shi (JP)

(73) Assignee: Aisin Seiki Kabushiki Kaisha, Kariya-shi (JP)

(21) Appl. No.: 15/267,836

(22) Filed: Sep. 16, 2016

(30) Foreign Application Priority Data
Sep. 17, 2015 (JP) 2015-183824

(51) Int. Cl. H02P 27/08; E05F 15/659; H02M 7/5387

(52) U.S. Cl. CPC H02P 27/08; H02M 7/53871; E05F 15/659; E05Y 2201/434; E05Y 2400/36; E05Y 2900/531

(57) ABSTRACT

A vehicular opening/closing body control device includes: a driving device that drives an opening/closing body of a vehicle using a motor as a driving source; a motor drive circuit that is formed in such a way that a plurality of switching elements are connected to each other in a bridge form; a bypass circuit that forms a regenerative brake circuit via a freewheel diode of the switching element; and a voltage clamping device that is provided in the bypass circuit.

### CROSS REFERENCE TO RELATED APPLICATIONS

This application is based on and claims priority under 35 U.S.C. §119 to Japanese Patent Application 2015-183824, filed on Sep. 17, 2015, the entire contents of which are incorporated herein by reference.

### TECHNICAL FIELD

This disclosure relates to a vehicular opening/closing body control device.

### BACKGROUND DISCUSSION

In the related art, as an opening/closing body control device for a vehicle which drives an opening/closing body of a vehicle using a motor as a driving source, there is a device which controls a moving speed of the opening/closing body by using a regenerative brake action of the motor. For example, in a case where a sliding door is stopped during an opening and closing operation, a sliding door control device disclosed in JP 2014-194151A (Reference 1) performs a regenerative brake control to short-circuit an input terminal of a motor so that a braking force is applied to the sliding door. That is, according to such a configuration, the sliding door can be prevented from moving at a high speed due to gravity, for example, in a case where the vehicle is stopped on a slope. Furthermore, if a duty ratio in the regenerative brake control is lowered in accordance with elapse of time and the braking force is gradually weakened, the sliding door can be smoothly moved in a direction in which gravity acts.

However, in order to perform the regenerative brake control described above, it is necessary to perform an on/off operation of each switching element configuring a motor drive circuit. That is, for example, in a case where supply of power to the motor drive circuit including a gate driving voltage input to each of the switching elements as a motor control signal is disrupted as in a case where an onboard power supply (battery) is removed, it is difficult to apply a braking force based on the regenerative brake action to an opening/closing body. For that reason, in such a case, a gentle movement of the opening/closing body may not be guaranteed when using the above related art only, and thus there is room for improvement in this regard.

### SUMMARY

Thus, a need exists for a vehicular opening/closing body control device which is not suspectable to the drawback mentioned above.

It is preferable that a vehicular opening/closing body control device according to an aspect of this disclosure includes a driving device that drives an opening/closing body of a vehicle using a motor as a driving source; a motor drive circuit that is formed in such a way that a plurality of switching elements are connected to each other in a bridge form; a bypass circuit that forms a regenerative brake circuit via a freewheel diode of the switching element; and a voltage clamping device that is provided in the bypass circuit.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a view illustrating a schematic configuration of a power sliding door device;

FIG. 2 is a view illustrating a bypass circuit and a Zener diode provided in a motor drive circuit in a first embodiment;

FIGS. 3A and 3B are views illustrating actions of the bypass circuit and the Zener diode provided in the motor drive circuit in the first embodiment;

FIG. 4 is a view illustrating a bypass circuit and a Zener diode provided in a motor drive circuit in a second embodiment;

FIG. 5 is a view illustrating a bypass circuit and a Zener diode provided in a motor drive circuit of another example;

FIG. 6 is a view illustrating a bypass circuit and a Zener diode provided in a motor drive circuit of still another example;

FIG. 7 is a view illustrating a bypass circuit and a Zener diode provided in a motor drive circuit of still another example;

FIG. 8 is a view illustrating a bypass circuit and a Zener diode provided in a motor drive circuit of still another example;

FIGS. 9A and 9B are views illustrating a bypass circuit and a Zener diode provided in a motor drive circuit of still another example; and

FIG. 10 is a view illustrating a bypass circuit and a Zener diode provided in a motor drive circuit of still another example.

### DETAILED DESCRIPTION

### First Embodiment

Hereinafter, a first embodiment disclosed here embodying a vehicular opening/closing body control device to a power sliding door device will be described with reference to drawings.

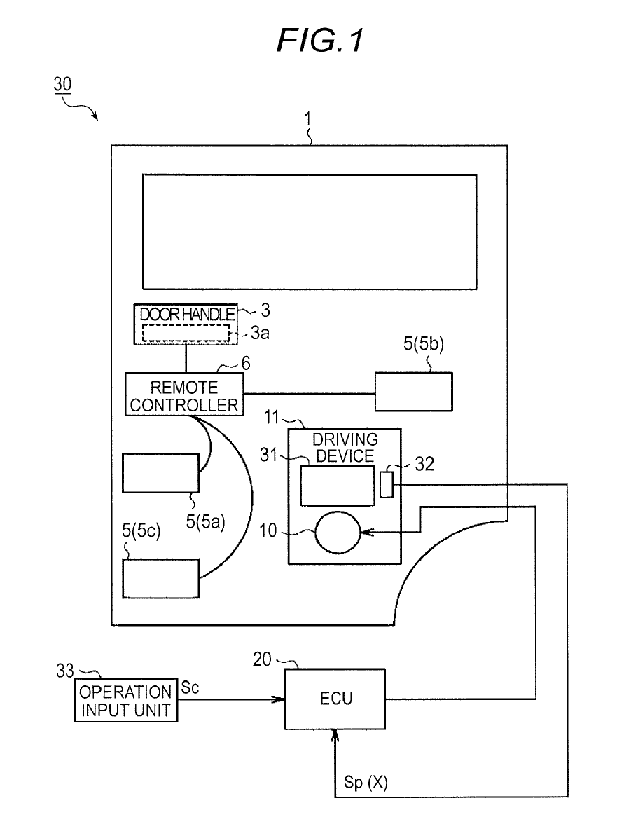

As illustrated in FIG. 1, the sliding door 1 as an opening/closing body supported on a side surface of a vehicle (not illustrated) moves in the back and forth direction so as to open and close a door opening part (not illustrated) provided on the side surface of the vehicle. Specifically, this sliding door 1 is configured so as to be a fully closed state closing this door opening part by moving to the vehicle front side (left side in FIG. 1), and so as to be a fully opened state in which a passenger can be getting on and off through this door opening part by moving to the vehicle rear side (right side in FIG. 1). A door handle 3 is provided for an opening and closing operation of the sliding door 1 in this sliding door 1.

A plurality of lock devices 5 are provided in this sliding door 1. A front lock 5a and a rear lock 5b are provided as a fully closed lock restraining the sliding door 1 in a fully closed position in this sliding door 1. Furthermore, a fully opened lock 5c is provided for restraining the sliding door 1 in a fully opened position in this sliding door 1. Each of these lock devices 5 is connected to the door handle 3 via a remote controller 6 in the sliding door 1 of the embodiment.

That is, the sliding door 1 of the embodiment operates an operation unit (outer handle and inner handle) 3a of the door handle 3 so that a restraint state of each of the lock devices 5 is released. This sliding door 1 is able to release the restraint state of each of the lock devices 5 by not only a remote operation but also an operation switch or a portable device provided in a vehicle cabin which the passenger operates. This sliding door 1 can manually perform an opening and closing operation using the door handle 3 as a gripping portion.

A driving device 11 is provided using a motor 10 as a driving source in the sliding door 1 of the embodiment. Furthermore, the motor 10 of this driving device 11 rotates by receiving a supply of a driving power from an ECU 20. That is, the ECU 20 controls an operation of the driving device 11 through the supply of the driving power to the motor 10. Thereby, in the embodiment, the power sliding door device 30 is formed as the vehicular opening/closing body control device capable of opening operation and closing operation of the sliding door 1 based on a driving force of the motor 10.

In detail, the driving device 11 of the embodiment is provided with a drum device 31 rotating based on the driving force of the motor 10. The driving device 11 of the embodiment has a well-known configuration driving for opening and closing the sliding door 1 via a driving cable (not illustrated) capable of winding this drum device 31.

A pulse sensor 32 which outputs a pulse signal Sp synchronized with the operation of the drum device 31 is provided in the driving device 11 of the embodiment. The ECU 20 of the embodiment detects a movement position X of the sliding door 1 driven by the driving device 11 based on a pulse output of the pulse sensor 32.

Furthermore, the output signal of an operation input unit 33 (operation input signal Sc) provided in the door handle 3, the vehicle cabin or the portable device is subjected to be input in the ECU 20 of the embodiment. That is, the ECU 20 of the embodiment detects a operation request of the sliding door 1 by an user based on this operation input signal Sc. In order to move the sliding door 1 to a requested operation direction, a configuration which controls the operation of the driving device 11 is formed.

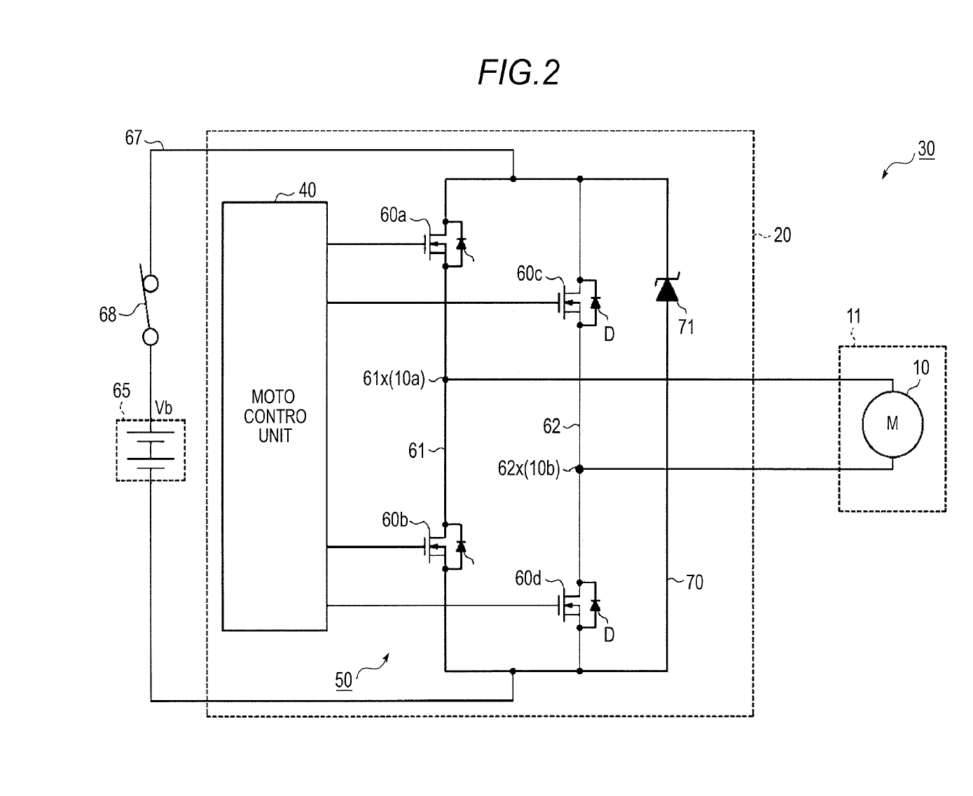

Further in detail, as illustrated in FIG. 2, the ECU 20 of the embodiment is provided with a motor control unit 40 generating a motor control signal for controlling a rotation of the motor 10 in order to operate the opening and closing of the sliding door 1 and a motor drive circuit 50 supplying the driving power to the motor 10 based on the motor control signal which this motor control unit 40 outputs. A DC motor with a brush is adopted as the motor 10 functioning as the driving source in the driving device 11 of the embodiment. A well-known PWM inverter formed in such a way that a plurality of switching elements (field effect transistor: FET) which on/off operate based on this motor control signal are connected to each other in a bridge form, is used as the motor drive circuit 50 of the embodiment.

Specifically, the motor drive circuit 50 of the embodiment has a so-called H bridge type configuration in which a first switching arm 61 including a pair of FETs 60a and 60b which are connected in series and a second switching arm 62 including a pair of FETs 60c and 60d similarly which are connected in series are connected in two parallel rows. This motor drive circuit 50 has the configuration in which a power supply voltage Vb of an onboard power supply 65 is applied to each of the FETs 60a and 60c of an upper stage side (upper side in FIG. 2) in the first switching arm 61 and the second switching arm 62, and each of the FETs 60b and 60d of a lower stage side (lower side in FIG. 2) in the first switching arm 61 and the second switching arm 62 is grounded. A connection point 61x of each of the FETs 60a and 60b in the first switching arm 61 and a connection point 62x of each of the FETs 60c and 60d in the second switching arm 62 are respectively an output terminal supplying the driving power to the motor 10, that is, a first motor terminal 10a and a second motor terminal 10b.

That is, in a case where the motor 10 is rotated in a first direction, the motor control unit 40 of the embodiment turns on the FET 60a of the upper stage side, turns off the FET 60b of the lower stage side in the first switching arm 61, turns on the FET 60d of the lower stage side, and turns off the FET 60c of the upper stage side in the second switching arm 62 by the output of the motor control signal. In a case where the motor 10 is rotated in a second direction, the motor control unit 40 turns on the FET 60c of the upper stage side, turns off the FET 60d of the lower stage side in the second switching arm 62, turns on the FET 60b of the lower stage side, and turns off the FET 60a of the upper stage side in the first switching arm 61 by the output of the motor control signal. The motor control unit 40 of the embodiment controls an on-duty ratio in each of the FETs 60a to 60d through the output of the motor control signal. Therefore, the motor control unit 40 is able to cause an output torque of the motor 10 to be changed.

The motor drive circuit 50 of the embodiment has a configuration in which a parasitic diode of each of the FETs 60a to 60d functions as a freewheel diode D thereof. A relay switch 68 is provided in the middle of a power supply line 67 connecting this motor drive circuit 50 and the onboard power supply 65.

A bypass circuit 70 connected to the above first and the second switching arms 61 and 62 in parallel is provided in the motor drive circuit 50 of the embodiment. A Zener diode 71 is provided as a voltage clamping device in this bypass circuit 70.

Further in detail, a connection direction and a breakdown voltage are set so that a through current does not flow through the bypass' circuit 70 in this Zener diode 71. Specifically, the breakdown voltage of this Zener diode 71, that is, a clamp voltage as the voltage clamping device is set to a value that is higher than the power supply voltage Vb applied to the motor drive circuit 50, and is lower than a maximum value of an induced voltage which can be generated by the motor 10 being in a regenerative state. Thereby, the motor drive circuit 50 of the embodiment has a configuration in which a regenerative brake circuit 80 is formed via the freewheel diode D of each of the FETs 60a to 60d by the bypass circuit 70 having this Zener diode 71.

That is, for example, even in a case where the sliding door 1 performs the opening and closing operation by an external force such as gravity, the driving device 11 of the embodiment has a configuration in which the motor 10 is rotated. Thereby, the induced voltage (counter electromotive voltage) is generated in a motor coil.

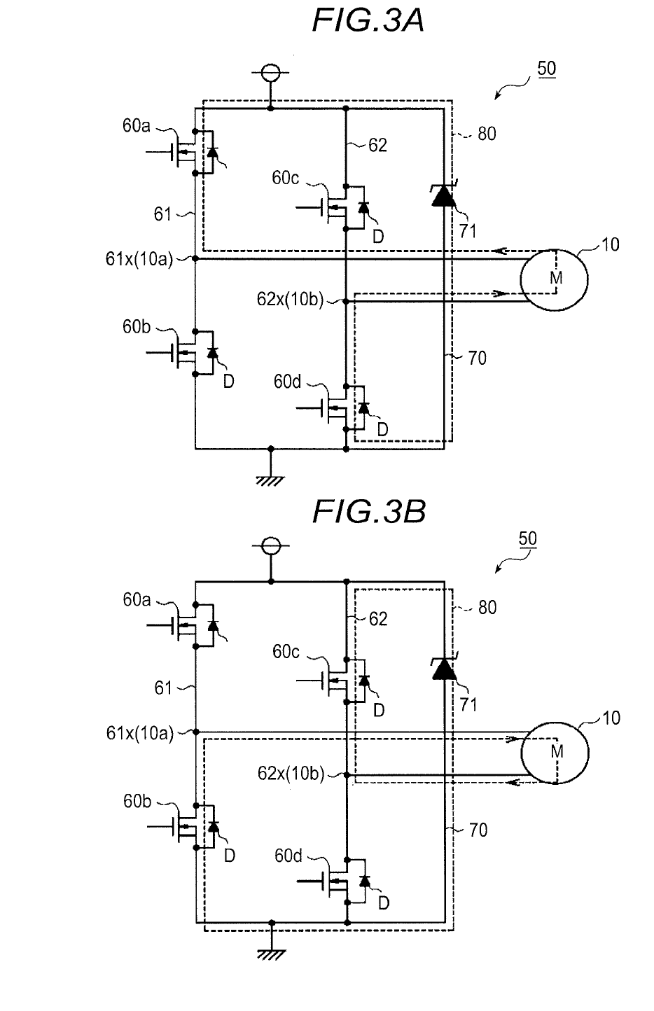

As illustrated in FIGS. 3A and 3B, even if all of the FETs 60a to 60d are in an off state in this time, the motor drive circuit 50 of the embodiment is subjected to form a closed circuit including the motor 10, that is, to form the regenerative brake circuit 80 through the freewheel diode D of each of the FETs 60a to 60d and the above bypass circuit 70. A moving speed of the sliding door 1 is increased, that is, a rotational speed of the motor 10 is increased by the external force, and the induced voltage exceeds the breakdown voltage of the Zener diode 71 provided in the bypass circuit 70. Therefore, a regenerative current is configured to flow through the regenerative brake circuit 80 that the bypass circuit 70 forms.

Specifically, as illustrated in FIG. 3A, in a case where the induced voltage occurs so that the first motor terminal 10a is a high potential side and the second motor terminal 10b is a low potential side, the bypass circuit 70 forms the regenerative brake circuit 80 that bypasses the FET 60b of the lower stage side in the first switching arm 61 and the FET 60c of the upper stage side in the second switching arm 62. The rotational speed of the motor 10 is increased and the induced voltage exceeds the breakdown voltage of the Zener diode 71. Therefore, the regenerative current is subjected to flow through the regenerative brake circuit 80 via each of the freewheel diodes D of the FET 60a of the upper stage side in the first switching arm 61 and the FET 60d of the lower stage side in the second switching arm 62.

As illustrated in FIG. 3B, in a case where the induced voltage occurs so that the second motor terminal 10b is the high potential side and the first motor terminal 10a is the low potential side, the bypass circuit 70 forms the regenerative brake circuit 80 that bypasses the FET 60a of the upper stage side in the first switching arm 61 and the FET 60d of the lower stage side in the second switching arm 62. The rotational speed of the motor 10 is increased and the induced voltage exceeds the breakdown voltage of the Zener diode 71. Therefore, the regenerative current is subjected to flow through the regenerative brake circuit 80 via each of the freewheel diodes D of the FET 60b of the lower stage side in the first switching arm 61 and the FET 60c of the upper stage side in the second switching arm 62.

Hereinbefore, according to the embodiment, the following effects can be obtained.

(1) The power sliding door device 30 as the vehicular opening/closing body control device is provided with the driving device 11 driving the sliding door 1 as the opening/closing body using a motor 10 as a driving source, and the motor drive circuit 50 formed by the plurality of the switching elements (FETs 60a to 60d) in the bridge form being connected to each other. The bypass circuit 70 that forms the regenerative brake circuit 80 via the freewheel diode D of each of the FETs 60a to 60d is provided in the motor drive circuit 50. The Zener diode 71 is provided as the voltage clamping device in this bypass circuit 70.

According to the above-described configuration, even in a case where the supply of power to the motor drive circuit 50 is disrupted and all of the FETs 60a to 60d are in an off state, the induced voltage generated by the motor 10 being in the regenerative state exceeds the breakdown voltage of the Zener diode 71. Therefore, the regenerative current flows through the regenerative brake circuit 80 that the bypass circuit 70 forms. That is, the rotational speed of the motor 10 is increased in accordance with the moving speed of the sliding door 1 that operates the opening and closing by the external force is increased. Therefore, a braking force based on the regenerative brake action is applied to the sliding door 1. Thereby, the gentle opening and closing operation of the sliding door 1 can be guaranteed.

The moving speed of the sliding door 1 which the braking force based on the regenerative brake action is applied depends on a magnitude of the breakdown voltage of the Zener diode 71. Accordingly, according to the above-described configuration, the maximum moving speed of the sliding door 1 in the design stage can be determined.

(2) the motor drive circuit 50 has a configuration in which the first switching arm 61 including the pair of FETs 60a and 60b which are connected in series and the second switching arm 62 including the pair of FETs 60c and 60d similarly which are connected in series are connected in two parallel rows. The bypass circuit 70 is provided in parallel to the first switching arm 61 and the second switching arm 62.

According to the above-described configuration, according to a generation direction of the induced voltage, that is, a rotation direction of the motor 10 accompanying the movement of the sliding door 1 by the external force, the bypass circuit 70 forms the regenerative brake circuit 80, while accompanied by a transition of each of the FETs 60a to 60d that the regenerative current flows via each of the FETs 60a to 60d and the freewheel diode D bypassing the direction. Thereby, regardless of the rotation direction of the motor 10, the braking force based on the regenerative brake action can be applied to the sliding door 1.

### Second Embodiment

Hereinafter, a second embodiment disclosed here embodying the vehicular opening/closing body control device to the power sliding door device will be described with reference to drawings. For convenience of the description, the same configuration as the above first embodiment is denoted by the same reference numerals, and the description thereof will be omitted.

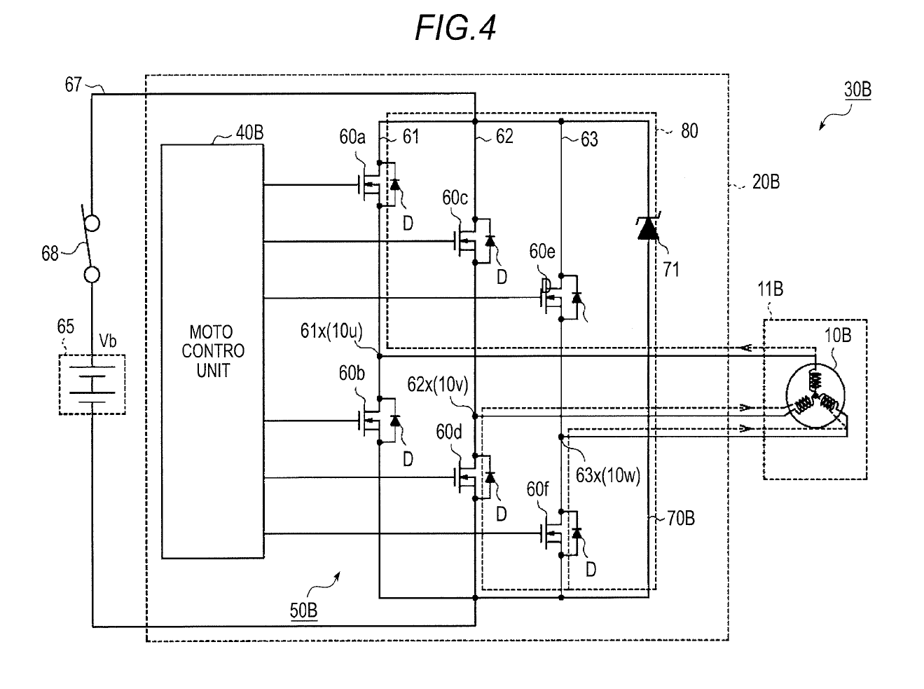

As illustrated in FIG. 4, a brushless motor having a motor coil of three-phase (U, V, and W) is adopted in the motor 10B of the driving device 11 B in the power sliding door device 30B of the embodiment. In accordance with this, the well-known PWM inverter formed in such a way that first to third switching arms 61 to 63 having the pair of the FETs 60a and 60b, the pair of the FETs 60c and 60d, and the pair of the FETs 60e and 60f which are connected in series are connected in three parallel rows is used in the motor drive circuit 50B.

That is, the first to third switching arms 61 to 63 configuring the motor drive circuit 50B are respectively provided corresponding to each phase of the motor 10. Each of the connection points 61x to 63x between each of the FETs 60a and 60b, between each of the FETs 60c and 60d, and between each of the FETs 60e and 60f configuring the first to third switching arms 61 to 63 is respectively the output terminal supplying the driving power to the motor 10B, that is, motor terminals 10u, 10v, and 10w of each phase corresponding to the motor coil of U, V, and W phases.

A rotation angle (electrical angle) of the motor 10B is input in the motor control unit 40B of the embodiment. This motor control unit 40B switches an energizing pattern corresponding to the rotation angle of the motor 10B, that is, the on/off state of each of the FETs 60a and 60b, each of the FETs 60c and 60d, and each of the FETs 60e and 60f configuring the first to third switching arms 61 to 63 through the output of the motor control signal. Therefore, the motor control unit 40B is configured to control the rotation of the motor 10B.

Furthermore, the bypass circuits 70B connected in parallel to the above first to third switching arms 61 to 63 are provided even in the ECU 20B and the motor drive circuit 50B of the embodiment. The Zener diode 71 is provided as the voltage clamping device even in this bypass circuit 70B, similar to the bypass circuit 70 in the above first embodiment.

That is, the direction of the induced voltage generated in the motor coil with each phase according to the rotation angle (electrical angle) varies in the motor 10B having the motor coil of three-phase (U, V, and W). On the other hand, the bypass circuit 70B of the embodiment is configured to form the regenerative brake circuit 80, while accompanied by the transition of each of the FETs 60a to 60f that the regenerative current flows via each of the FETs 60a to 60f and the freewheel diode D bypassing the direction, according to the direction of the induced voltage generated in the motor coil with each phase. One pattern of the regenerative brake circuit 80 that the bypass circuit 70B forms is illustrated in FIG. 4. Thereby, even in a case where the supply of power to the motor drive circuit 50B is disrupted, the power sliding door device 30B of the embodiment can apply the braking force to the sliding door 1 based on the regenerative brake action, similar to the power sliding door device 30 in the above first embodiment.

Each of the above embodiments may be modified as follows.

In each of the above-described embodiments, the power sliding door device 30 that causes the sliding door 1 provided on the side surface of the vehicle to operate the opening and closing is embodied. However, without being limited thereto, for example, the embodiment may be applied to the vehicular opening/closing body control device targeting the opening/closing body other than the sliding door such as a sunroof device.

in each of the above-described embodiments, although the Zener diode 71 is used as the voltage clamping device, without being limited thereto, for example, it may be configured to use a varistor.

In each of the above-described embodiments, the FET (field effect transistor) is used to each of the switching elements configuring the motor drive circuit 50 (50B). The parasitic diode functions as the freewheel diode D. However, without being limited thereto, insofar as the configuration has the freewheel diode D, the switching element may be arbitrarily changed.

in the above first embodiment, the bypass circuit 70 is provided in parallel to the first and second switching arms 61 to 62 configuring the motor drive circuit 50. However, without being limited thereto, it may be configured to include the bypass circuit provided in parallel to any of the switching elements configuring the motor drive circuit.

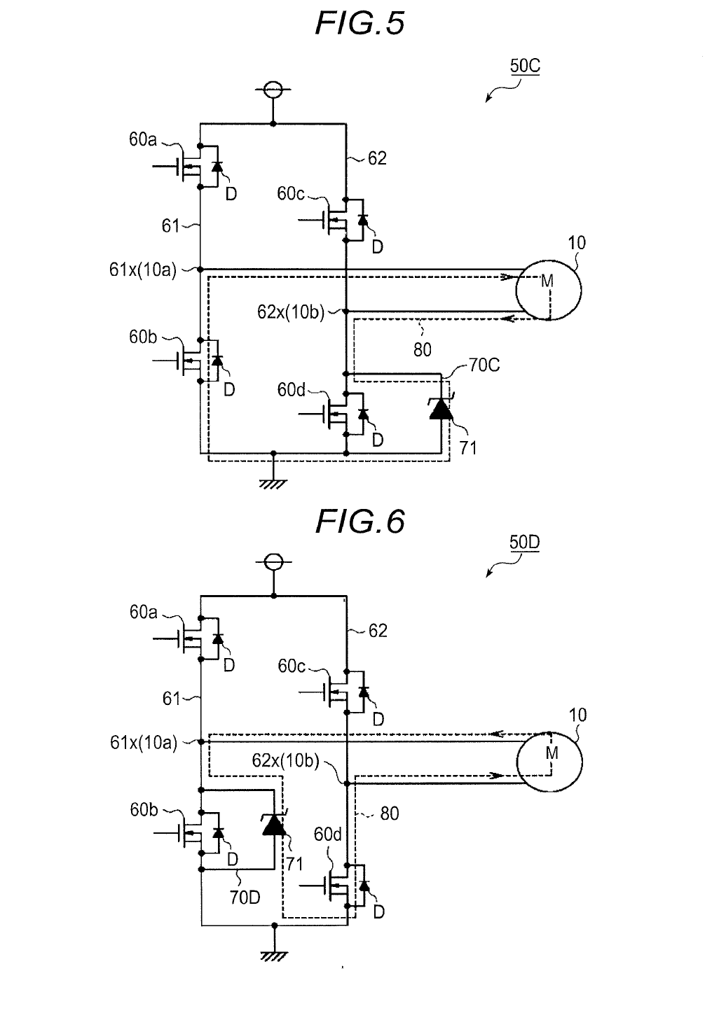

For example, as the motor drive circuit 50C illustrated in FIG. 5, it may be configured to include the bypass circuit 70C provided in parallel to the FET 60d of the lower stage side in the second switching arm 62. By adopting such configuration, in a case where the motor 10 rotates in the direction which the induced voltage occurs so that the second motor terminal 10b is the high potential side and the first motor terminal 10a is the low potential side, the bypass circuit 70C forms the regenerative brake circuit 80 that bypasses the above FET 60d provided in parallel to the bypass circuit 70C. The regenerative current flows through the regenerative brake circuit 80 via the freewheel diode D of the FET 60b of the lower stage side in the first switching arm 61. Therefore, a regenerative brake can be applied to the sliding door 1 moving by the external force while accompanied by such rotation of the motor.

As the motor drive circuit 50D illustrated in FIG. 6, it may be configured to include the bypass circuit 70D provided in parallel to the FET 60b of the lower stage side in the first switching arm 61. By adopting such configuration, in a case where the motor 10 rotates in the direction which the induced voltage occurs so that the first motor terminal 10a is the high potential side and the second motor terminal 10b is the low potential side, the bypass circuit 70D forms the regenerative brake circuit 80 that bypasses the above FET 60b provided in parallel to the bypass circuit 70D. The regenerative current flows through the regenerative brake circuit 80 via the freewheel diode D of the FET 60d of the lower stage side in the second switching arm 62. Therefore, the regenerative brake can be applied to the sliding door 1 moving by the external force while accompanied by such rotation of the motor.

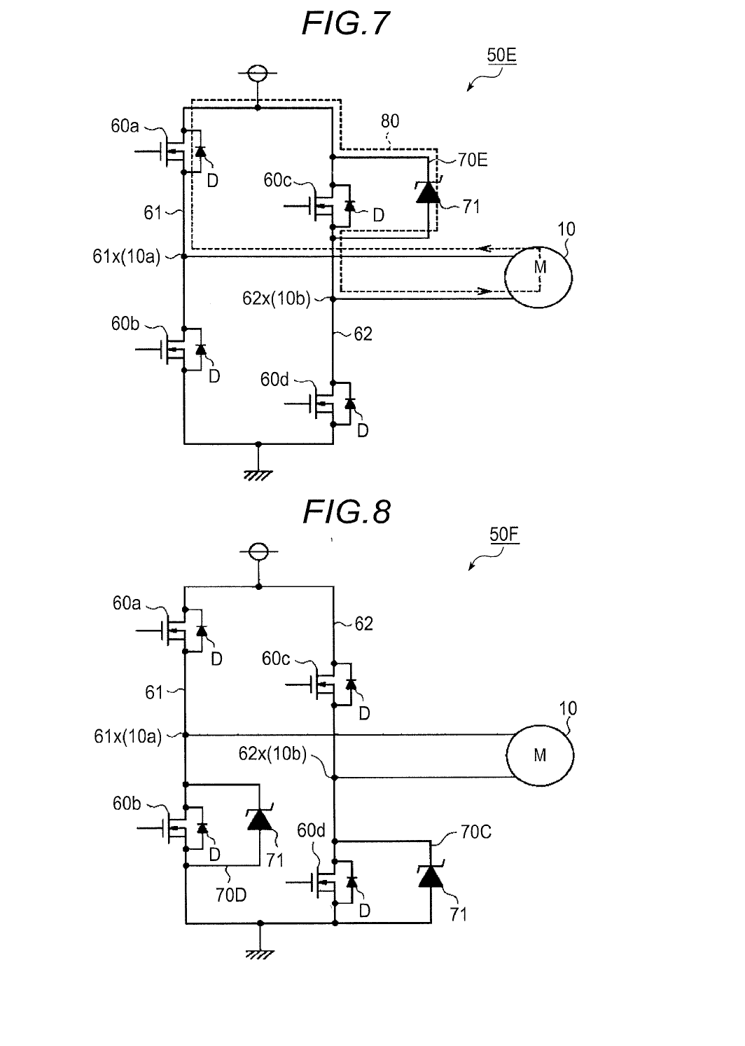

Furthermore, as the motor drive circuit 50E illustrated in FIG. 7, it may be configured to include the bypass circuit 70E provided in parallel to the FET 60c of the upper stage side in the second switching arm 62. By adopting such configuration, in a case where the motor 10 rotates in the direction which the induced voltage occurs so that the first motor terminal 10a is the high potential side and the second motor terminal 10b is the low potential side, the bypass circuit 70E forms the regenerative brake circuit 80 that bypasses the above FET 60c provided in parallel to the bypass circuit 70E. The regenerative current flows through the regenerative brake circuit 80 via the freewheel diode D of the FET 60a of the upper stage side in the first switching arm 61. Therefore, the regenerative brake can be applied to the sliding door 1 moving by the external force while accompanied by such rotation of the motor.

That is, the bypass circuit 70 having the voltage clamping device is provided in parallel to any one of each of the FETs 60a to 60d configuring the motor drive circuit 50. Therefore, only in a case where the motor 10 rotates in any one of directions, the bypass circuit 70 forms the regenerative brake circuit 80. Thereby, the braking force based on the regenerative brake action can be applied to only one side in the moving direction for the sliding door 1 being moved by the external force.

Specifically, an equal effect can be obtained in the configuration provided with the bypass circuit 70D in parallel with the FET 60b of the lower stage side in the first switching arm 61 (refer to FIG. 6) and the configuration provided with the bypass circuit 70E in parallel with the FET 60c of the upper stage side in the second switching arm 62 (refer to FIG. 7). The equal effect can be obtained in the configuration provided with the bypass circuit 70C in parallel with the FET 60d of the lower stage side in the second switching arm 62 (refer to FIG. 5) and the configuration provided with the bypass circuit 70 in parallel with the FET 60a of the upper stage side in the first switching arm 61.

In this case, the rotation direction of the motor capable of applying the braking force based on the regenerative brake action may be set in a direction where the sliding door 1 performs the closing operation. That is, in a case of considering a possibility that pinching occurs by the sliding door 1, it is desirable to limit the moving speed during the closing operation. Thereby, the gentle closing operation of the sliding door 1 can be guaranteed.

Furthermore, as the motor drive circuit 50F illustrated in FIG. 8, it may be configured to be provided with the bypass circuit 70C in parallel with the FET 60d of the lower stage side in the second switching arm 62 and the bypass circuit 70D in parallel with the FET 60b of the lower stage side in the first switching arm 61. It may be configured to be provided with the bypass circuits respectively to each of the FETs 60a and 60c of the upper stage side. By adopting such configuration, regardless of the rotation direction of the motor 10, the braking force based on the regenerative brake action can be applied to the sliding door 1.

In the above second embodiment, the bypass circuit 70B is provided in parallel to the first to third switching arms 61 to 63 configuring the motor drive circuit 50B. However, without being limited thereto, even for the motor drive circuit for such brushless motor, it may be configured to include the bypass circuit provided in parallel to any of the switching elements configuring the motor drive circuit.

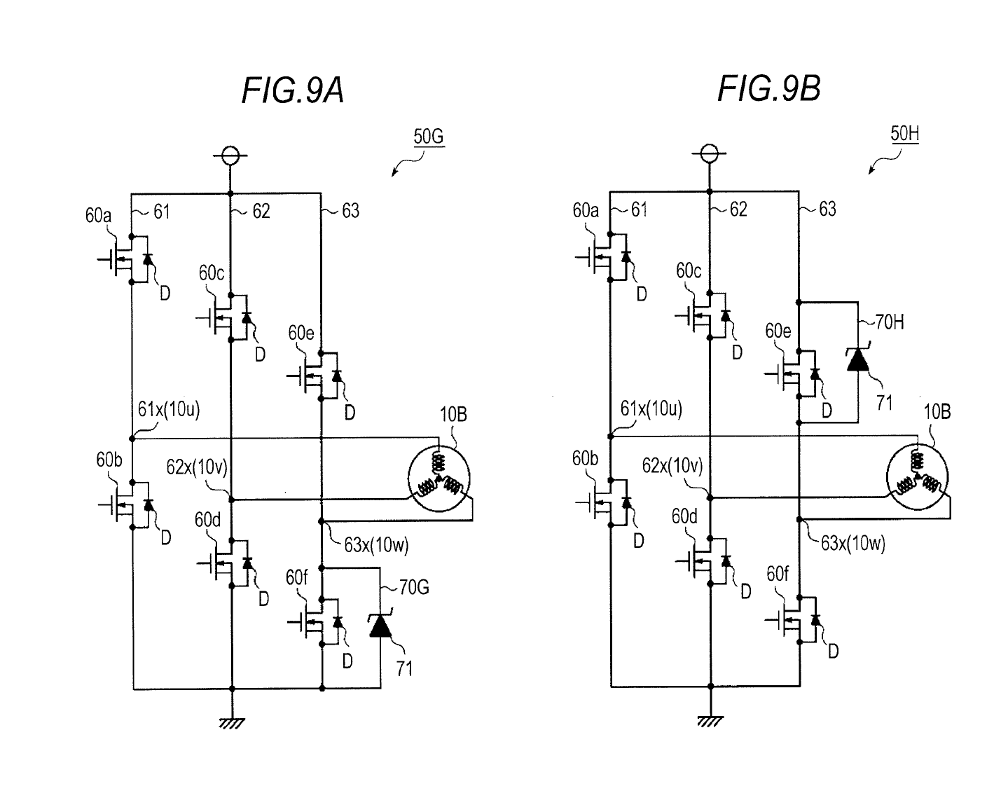

For example, as the motor drive circuit 50G illustrated in FIG. 9A, it may be configured to include the bypass circuit 70G provided in parallel to the FET 60f of the lower stage side in the third switching arm 63. By adopting such configuration, the bypass circuit 70G forms the regenerative brake circuit 80 that bypasses the above FET 60f provided in parallel to the bypass circuit 70G. Even in this case, the FET in which the regenerative current flows via the freewheel diode D transits according to the rotation angle (electrical angle) of the motor 10. Thereby, regardless of the rotation direction of the motor 10B, in the rotation angle range of the motor 10B (electrical angle) equivalent to one phase of the motor coil, that is, one third of a revolution of the motor 10 corresponding to the third switching arm 63, the braking force based on the regenerative brake action can be applied to the sliding door 1 moving by the external force.

As the motor drive circuit 50H illustrated in FIG. 9B, it may be configured to include the bypass circuit 70H provided in parallel to the FET 60e of the upper stage side in the third switching arm 63. Even such configuration is adopted, the same effect as the motor drive circuit 50G illustrated in FIG. 9A can be obtained. Even in a case where the bypass circuit 70 is provided in parallel to any one of each of the FETs 60a and 60b configuring the first switching arm 61 and each of the FETs 60c and 60d configuring the second switching arm 62, the same effect can be obtained.

Furthermore, it may be configured to be provided with the bypass circuit 70 in parallel to any two of each of the FETs 60a, 60c, and 60e of the upper stage side (power side) or any two of each of the FETs 60b, 60d, and 60f of the lower stage side (ground side) configuring the motor drive circuit for the brushless motor.

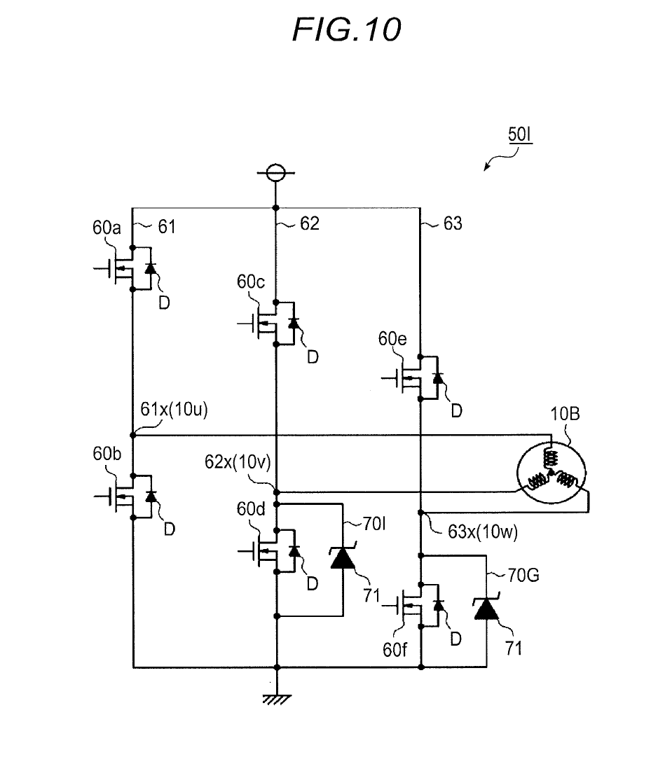

For example, as the motor drive circuit 501 illustrated in FIG. 10, it may be configured to include the bypass circuit 70G provided in parallel to the FET 60f of the lower stage side in the third switching arm 63 and the bypass circuit 701 provided in parallel to the FET 60d of the lower stage side in the second switching arm 62. Thereby, regardless of the rotation direction of the motor 10B, in the rotation angle range of the motor 10B (electrical angle) equivalent to two phases of the motor coil, that is, two third of a revolution of the motor 10 corresponding to the second and third switching arms 62 and 63, the braking force based on the regenerative brake action can be applied to the sliding door 1 moving by the external force.

Furthermore, it may be configured to be provided with the bypass circuit 70 in parallel to all of the FETs 60a, 60c, and 60e of the upper stage side (power side) or all of the FETs 60b, 60d, and 60f of the lower stage side (ground side) configuring the motor drive circuit for the brushless motor. By being such configuration, regardless of the rotation direction and the rotation angle of the motor 10B accompanying the movement of the sliding door 1, the bypass circuit 70 forms the regenerative brake circuit 80. Thereby, the braking force based on the regenerative brake action can be stably applied to the sliding door 1.

Next, technical ideas that can be grasped from the above embodiments will be described with the effect.

It is preferable that a vehicular opening/closing body control device according to an aspect of this disclosure includes a driving device that drives an opening/closing body of a vehicle using a motor as a driving source; a motor drive circuit that is formed in such a way that a plurality of switching elements are connected to each other in a bridge form; a bypass circuit that forms a regenerative brake circuit via a freewheel diode of the switching element; and a voltage clamping device that is provided in the bypass circuit.

According to this configuration, even in a case where the supply of power to the motor drive circuit is disrupted, and all of the switching elements are in an off state, an induced voltage generated by the motor being in a regenerative state exceeds a clamping voltage of a voltage clamping device. Therefore, a regenerative current flows through the regenerative brake circuit that the bypass circuit forms. That is, a rotational speed of the motor increases in accordance with a moving speed of the opening/closing body due to an external force increasing, and thus the braking force based on the regenerative brake action is applied to the opening/closing body. Thereby, gentle movement of the opening/closing body can be guaranteed.

In the vehicular opening/closing body control device, it is preferable that the voltage clamping device is a Zener diode.

According to this configuration, the voltage clamping device can be formed on the bypass circuit with a simple configuration.

In the vehicular opening/closing body control device, it is preferable that the motor drive circuit is formed in such a way that a plurality of switching arms including a pair of the switching elements which are connected in series are connected to each other in two parallel rows.

According to this configuration, even in a case where a DC motor with a brush is used as the driving source and the supply of power to the motor drive circuit is disrupted, the braking force based on the regenerative brake action can be applied to the opening/closing body.

In the vehicular opening/closing body control device, it is preferable that the motor drive circuit is formed in such a way that a plurality of switching arms including a pair of the switching elements which are connected in series are connected to each other in three parallel rows.

According to this configuration, even in a case where a brushless motor is used as the driving source and the supply of power to the motor drive circuit is disrupted, the braking force based on the regenerative brake action can be applied to the opening/closing body.

In the vehicular opening/closing body control device, it is preferable that the bypass circuit is provided in parallel to the switching arm.

According to this configuration, regardless of a rotation direction and a rotation angle of the motor accompanying the movement of the opening/closing body, the bypass circuit forms the regenerative brake circuit. Thereby, the braking force based on the regenerative brake action can be stably applied to the opening/closing body.

In the vehicular opening/closing body control device, it is preferable that one or a plurality of the bypass circuits are provided in parallel to the switching element.

According to this configuration, the bypass circuit forms the regenerative brake circuit bypassing the switching element provided in parallel to the bypass circuit. As a result, for example, in the motor drive circuit formed by first and second switching arms being connected to each other in two parallel rows, in a case where the bypass circuit is configured to be provided in parallel to any one of the switching elements, the bypass circuit forms the regenerative brake circuit only in a case where the motor rotates in any one direction. Thereby, the braking force based on the regenerative brake action can be applied to only one side in a moving direction, for example, only a closing direction for the opening/closing body being moved by the external force.

It is preferable that the vehicular opening/closing body control device includes the bypass circuits that are provided in parallel to one or the plurality of the switching elements on the power source side or one or the plurality of the switching elements on the ground side. Thereby, even in a case where the supply of power to the motor drive circuit is disrupted, the braking force based on the regenerative brake action can be applied to the opening/closing body.

For example, in the motor drive circuit formed by first to third switching arms being connected to each other in three parallel rows, the bypass circuit is provided in parallel to any one of the switching elements. In this case, regardless of the rotation direction of the motor, in a rotation angle range of the motor (electrical angle) equivalent to one phase of a motor coil corresponding to the switching arm having the switching element provided in the bypass circuit, that is, one third of a revolution of the motor, the braking force based on the regenerative brake action can be applied to the opening/closing body moving by the external force.

Furthermore, for example, in the motor drive circuit similarly formed by first to third switching arms being connected to each other in three parallel rows, the bypass circuit is provided in parallel to any two of the switching elements on a power source side or in parallel to any two of the switching elements on a ground side. In this case, regardless of the rotation direction of the motor, in the rotation angle range of the motor (electrical angle) equivalent to two phases of the motor coil, that is, two third of a revolution of the motor, the braking force based on the regenerative brake action can be applied to the opening/closing body moving by the external force. Regardless of whether the number of rows of switching arms is two or three, in a case where the bypass circuit is configured to be provided in parallel to all of the switching elements on the power source side or to all of the switching elements on the ground side, regardless of the rotation direction and the rotation angle of the motor, the braking force based on the regenerative brake action can be applied to the opening/closing body moving by the external force.

According to the aspect of this disclosure, even in a case where the supply of power to the motor drive circuit is disrupted, the braking force based on the regenerative brake action can be applied to the opening/closing body.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicular opening/closing body control device comprising:
a driving device that drives an opening/closing body of a vehicle using a motor as a driving source;
a motor drive circuit that is formed in such a way that a plurality of switching elements are connected to each other in a bridge form;
a bypass circuit that forms a regenerative brake circuit via a freewheel diode of the switching element; and
a voltage clamping device that is provided in the bypass circuit.

2. The vehicular opening/closing body control device according to claim 1,
wherein the voltage clamping device is a Zener diode.

3. The vehicular opening/closing body control device according to claim 1,
wherein the motor drive circuit is formed in such a way that a plurality of switching arms including a pair of the switching elements which are connected in series are connected to each other in two parallel rows.

4. The vehicular opening/closing body control device according to claim 1,
wherein the motor drive circuit is formed in such a way that a plurality of switching arms including a pair of the switching elements which are connected in series are connected to each other in three parallel rows.

5. The vehicular opening/closing body control device according to claim 3,
wherein the bypass circuit is provided in parallel to the switching arm.

6. The vehicular opening/closing body control device according to claim 4,
wherein the bypass circuit is provided in parallel to the switching arm.

7. The vehicular opening/closing body control device according to claim 3,
wherein one or a plurality of the bypass circuits are provided in parallel to the switching element.

8. The vehicular opening/closing body control device according to claim 4,
wherein one or a plurality of the bypass circuits are provided in parallel to the switching element.

9. The vehicular opening/closing body control device according to claim 7,
wherein the bypass circuits are provided in parallel to one or a plurality of the switching elements on a power source side or one or a plurality of the switching elements on a ground side.

10. The vehicular opening/closing body control device according to claim 8,
wherein the bypass circuits are provided in parallel to one or a plurality of the switching elements on a power source side or one or a plurality of the switching elements on a ground side.
